(19) United States
(12) Patent Application Publication
(10) Pub. No.: US 2013/0167075 A1
(43) Pub. Date: Jun. 27, 2013

(54) Managing Display Areas

(71) Applicants: Rupen Chanda, San Francisco, CA (US); Jani Leppanen, San Francisco, CA (US)

(72) Inventors: Rupen Chanda, San Francisco, CA (US); Jani Leppanen, San Francisco, CA (US)

(73) Assignee: Adobe Systems Incorporated, San Jose, CA (US)

(21) Appl. No.: 12/827,707

(22) Filed: Jun. 30, 2010

(51) Int. Cl. G06F 3/048

(52) U.S. Cl. 715/800; 715/781

(57) ABSTRACT

A computer-implemented method includes displaying a pane in a device, the pane having first and second content areas. The method further includes, in response to a command to add additional content to the first content area, selecting at least one action of a pan of the displayed pane and a zoom of the displayed pane, the action selected based on a size of the additional content. The method further includes performing the selected action to display a modified pane having the additional content in the first content area. Examples of a computer program product and a device are described.

### BACKGROUND

This specification relates to managing display panes in multimedia devices. For example, users can choose to display media content in display panes in a particular layout. Depending on the layout, content may need to be displayed smaller or larger in a specific display pane. The layout can also affect whether media content should be displayed in a horizontal or vertical orientation, or be shifted left or right, for example.

### SUMMARY

The invention relates to managing display areas.

In a first aspect, a computer-implemented method includes displaying a pane in a device, the pane having first and second content areas. The method further includes, in response to a command to add additional content to the first content area, selecting at least one action of a pan of the displayed pane and a zoom of the displayed pane, the action selected based on a size of the additional content. The method further includes performing the selected action to display a modified pane having the additional content in the first content area.

Implementations can include any or all of the following features. The additional content includes a message requiring a user input to be made using at least one control in the additional content, the action ensuring that the message and the control are visible in the modified pane. The method further includes determining that the size of the additional content requires the displayed pane to be panned to make the message and the control visible in the modified pane, wherein at least the pan of the displayed pane is performed. The method further includes determining that the size of the additional content requires the displayed pane to be zoomed to make the message and the control visible in the modified pane, wherein at least the zoom of the displayed pane is performed. The method further includes receiving the user input in the device after displaying the modified pane; and performing, in response to receiving the user input, another action of a panning action and a zooming action that at least in part reverses a result of the action. The method further includes determining existence of a condition after receiving the user input, wherein performance of the other action depends on the condition.

Content in the first content area and the additional content are swf-based. The action is also based on a characteristic of a physical screen on the device. The characteristic of the physical screen includes a physical-pixel density value. The method further includes determining, before performing the action, whether the first content area displayed on the device currently has focus, wherein performance of the action depends on whether the first content area has focus.

In a second aspect, a computer program product is tangibly embodied in a tangible program carrier and includes instructions that when executed by a processor perform a method. The method includes displaying a pane in a device, the pane having first and second content areas. The method includes, in response to a command to add additional content to the first content area, selecting at least one action of a pan of the displayed pane and a zoom of the displayed pane, the action selected based on a size of the additional content. The method includes performing the selected action to display a modified pane having the additional content in the first content area.

In a third aspect, a device includes a display; a content module implemented in a computer-readable storage device, the content module presenting on the display a pane having first and second content areas; and a pan and zoom module implemented in a computer-readable storage device. The pan and zoom module selects and performs, in response to a command to add additional content to the first content area, at least one action of a pan of the displayed pane and a zoom of the displayed pane, the action selected based on a size of the additional content. Based on the action a modified pane is presented on the display, the modified pane having the additional content in the first content area.

Implementations can include any or all of the following features. The additional content includes a message requiring a user input to be made using at least one control in the additional content, the action ensuring that the message and the control are visible in the modified pane. The pan and zoom module determines that the size of the additional content requires the displayed pane to be panned to make the message and the control visible in the modified pane, wherein the pan and zoom module performs at least the pan of the displayed pane. The pan and zoom module determines that the size of the additional content requires the displayed pane to be zoomed to make the message and the control visible in the modified pane, wherein the pan and zoom module performs at least the zoom of the displayed pane. The additional content and content in the first content area are swf-based. The action is also based on a physical-pixel density value of the display.

Particular embodiments of the subject matter described in this specification can be implemented to realize one or more of the following advantages. Manipulation of display size and strategic placement of media content can provide increased usability for a user interacting with device. A screen can be dynamically manipulated to accommodate interactive content.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for processing and presenting media content to one or more media playing devices.

FIGS. 2A-2D are screenshots of example content displayed on one or more display panes in a media playing device.

FIG. 3 is a sequential flow diagram of an example method for displaying a modified display pane in a media playing device.

Like reference numbers and designations in the various drawings indicate like elements.

### DETAILED DESCRIPTION

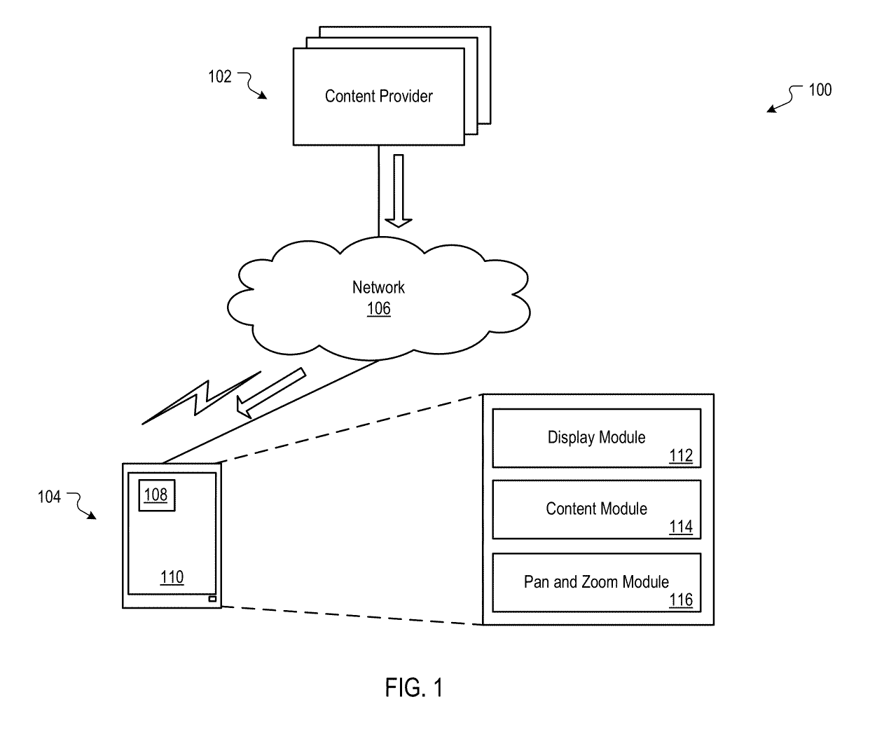

FIG. 1 is a block diagram of an example system 100 for processing media content and presenting it on one or more media playing devices. In general, the system 100 can facilitate serving and presentation of text, audio and/or video information from one or more content providers 102 to one or more media playing devices 104. The presentation of the media content can be configured or reconfigured based on device dimensions (e.g., a physical screen size including physical-pixel density values), display pane focus (e.g., determining which application has focus), media content size, or configured based on other input received or retrieved in system 100. Below will be described examples where a display screen is panned and/or zoomed when additional content is to be displayed, the panning/zooming based on a size of the additional content.

The system 100 can modify how media content is displayed within media playing device 104. For example, the system 100 can determine the size of received media content and dynamically reconfigure one or more display panes to ensure the received media content can be displayed in a convenient size and shape for the user. The dynamic reconfiguring of the display panes can generally include panning and/or zooming documents or window panes displayed within the device 104 such that the panning and/or zooming provides content in a centered convenient fashion within a particular display pane. Other configuring actions and modifications can be performed to appropriately display media content within device 104.

The system 100 can be used to supply media content to electronic media playing devices targeted toward multimedia enjoyment. The devices may include one or more of a television, a mobile telephone, a personal digital assistant (PDA), a cellular telephone, a mobile audio or video player, a game console, a Global Positioning System (GPS) receiver, a blu-ray player, a set-top box, an appliance, or other internet or network connectable digital device, to name just a few examples.

Media content presented in device 104 can, for example, include web services, web pages, images, advertisements, audio, video, and/or other interactive data. The media content may be accessed over the Internet, and/or any other network. For example, the media content can be forwarded from the content provider 102 to the media playing device 104, where data formatting, decoding, rendering, or other data operations are performed using the content. The system 100 can provide any combination of media content forms within device 104 including, but not limited to HTML text or animations, flash-based content (e.g., Shockwave® Flash® (swf) files—a proprietary file format associated with Adobe® Flash® products), video content (e.g., YouTube), audio content (e.g., streaming radio), or interactive media content (e.g., forms, games, etc.).

As shown in FIG. 1, the content provider(s) 102 are connectively coupled for communication with the media playing device(s) 104 over a network 106. The media playing device 104 shown in this example is an Internet-connected mobile phone device capable of presenting media content. A mobile phone device is depicted in FIG. 1 as an example, but in other implementations the media playing device 104 may include any device capable of receiving and playing content from content providers 102, or from other multimedia providers (not shown) via network 106. In some implementations, the media playing device 104 may be configured to play multiple media content types including, but not limited to, MP3 files and video files.

The media playing device 104 has one or more display devices, such as an LCD screen. Here, the display device currently presents a display pane with a first content area 108 and a second content area 110. In some implementations, the second content area 110 corresponds to the “main” content of a displayed page (e.g., text, graphics and/or functionality related to one or more topics), and the first content area 108 corresponds to “other” content (e.g., informational content)

The display pane with the content areas 108 and 110 can be zoomed, panned, moved, or otherwise manipulated to display media content items on the device 104. For example, the device 104 can determine how content is displayed in content area 108 based on device parameters such as screen size, pixel density, screen dpi (dots per inch), screen offsets, media content size, or other physical constraint. If the device 104 zooms in on the content in content area 108, the content area 110 may be zoomed a corresponding amount.

In some implementations, the system 100 can take physical device constraints into account to determine how to manipulate the display window pane size and placement of a particular document, window, or media content item. The manipulation of display window pane size and strategic placement of media content can provide increased usability for a user interacting with device 104. For example, the system 100 can automatically pan and/or zoom a particular pane or document when a dialog box or other message is presented within device 104. The panning and/or zooming actions can ensure that the content (e.g., dialog box or message) is (i) presented in a centered location within a pane and (ii) presented in an appropriate size to receive user interaction. In some implementations, the system 100 can later return zoomed and/or panned content items to previous sizes or settings, for example after the dialog box is presented and selected by a user.

The media playing device 104 may include one or more general computing components and/or embedded systems with specific components for performing specific tasks. The media playing device 104 may also include various other elements, such as components for running processes on various machines. Here, each device includes at least one or more processors, memory, a display module 112, a content module 114, and a pan and zoom module 116. Although only one media playing device 104 is depicted, the system 100 may provide media content over network 106 to any number of media playing devices.

The display module 112 can configure and control the display device, including content areas 108 and 110. The display module 112 can, for example, receive instructions or guidance from content module 114 and/or pan and zoom module 116. For example, the display module 112 can present media content fed from content module 114, and can perform display actions on the media content in the presentation according to instructions received from the pan and zoom module 116.

The content module 114 can receive media content from one or more content providers 102 and present the media content in a display where the display includes a pane with one or more content areas. For example, the content module 114 can present media content on device 104 in content areas 108 and/or 110 or another content area (not shown). The content module 114 is generally implemented in a computer-readable storage device.

The pan and zoom module 116 can perform movement in a document, screen, or other media content item in a vertical or horizontal fashion from an arbitrary stationary point. That is, a panning action can pan in any direction from a stationary point to successively reveal a broad view of the media content item. The pan and zoom module 116 can additionally zoom in or out on a document, screen, or other media content item. For example, the zooming action can provide a user with a display or input control that is easily read and accessed by a user.

From time to time, additional content is to be added to a content area. The command may invoke at least one action of: (i) a pan of the displayed pane (e.g., to center the content area 108) and (ii) a zoom of the displayed pane (e.g., to enlarge the content area 108). The device 104 can select a panning action, a zooming action, or both, depending on the circumstances. The selection of an action can be based on a size of the additional media content, for example. Depending on the selected action, a modified pane is presented on the display area within device 104.

The content providers 102 can provide multimedia content and related media services to users of media playing devices. The multimedia content may include drivers, modules, advertisements, libraries, services, signals, media player codecs, movies, television programs, and/or other content including such content that combines one or more of the above content items. Multimedia content can include embedded information, such as embedded media, videos, links, meta-information, and/or machine executable instructions. Multimedia content could also be communicated through RSS (Really Simple Syndication) feeds, radio channels, television channels, print media, websites, or other media. In some implementations, the content providers 102 can use the system 100 to provide subscribed access to online television content (e.g., Hulu, network television video, pay per view, etc.), movies, music, sound bytes, ring tones, images, and other media. In some implementations, content providers 102 can provide open access to any media or service downloadable from the Internet over network 106, for example.

The network 106 may include a local area network LAN, a WAN, the Internet, or a combination thereof, connecting content providers 102 and one or more media playing devices 104. In some implementations, the various components communicate via a virtual private network (VPN), Secure Shell (SSH) tunnel, or other secure network connection. Further, the system 100 may store some data at a relatively central location (e.g., accessible over a WAN), while concurrently maintaining local data at a user's site for redundancy and to allow processing during downtime.

The system 100 may include an element or system that facilitates communications among and between various content providers, servers, and media playing devices. The system 100 may be networked and include one or more telecommunications networks, such as computer networks, telephone, or other communications networks, the Internet, etc. In some implementations, the system 100 may facilitate data exchange by way of packet switching using the Internet Protocol (IP). In addition, the system 100 may facilitate wired and/or wireless connectivity and communication.

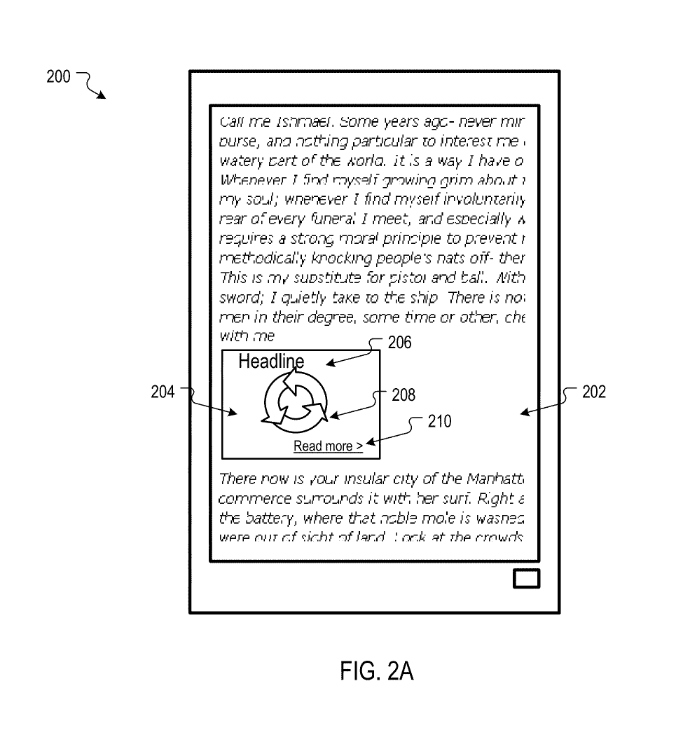

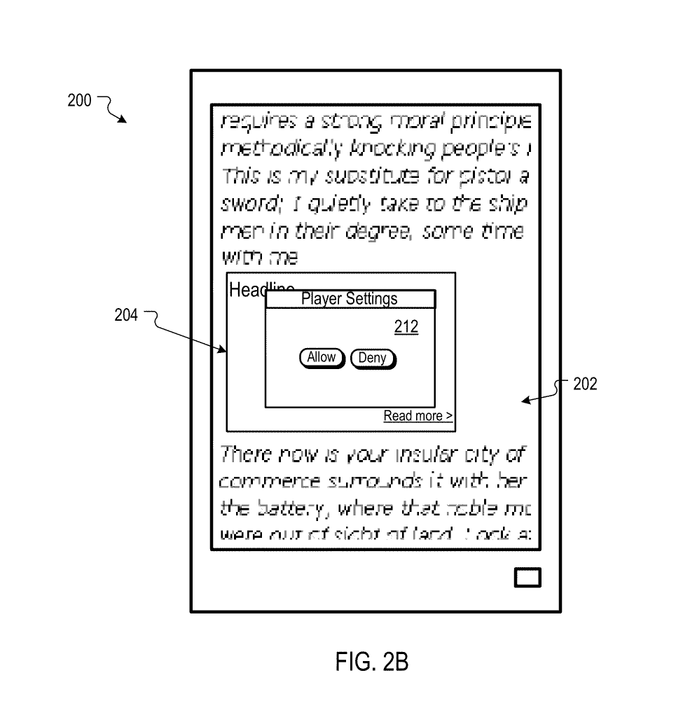

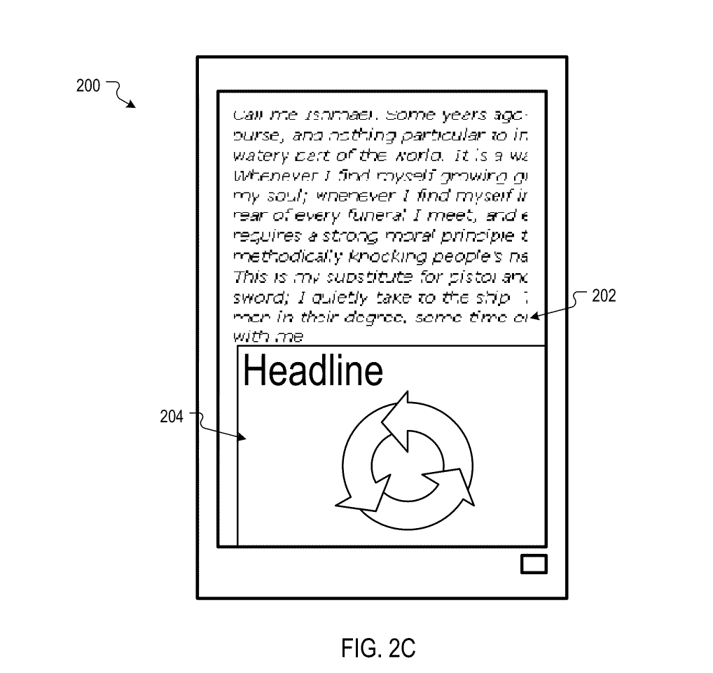

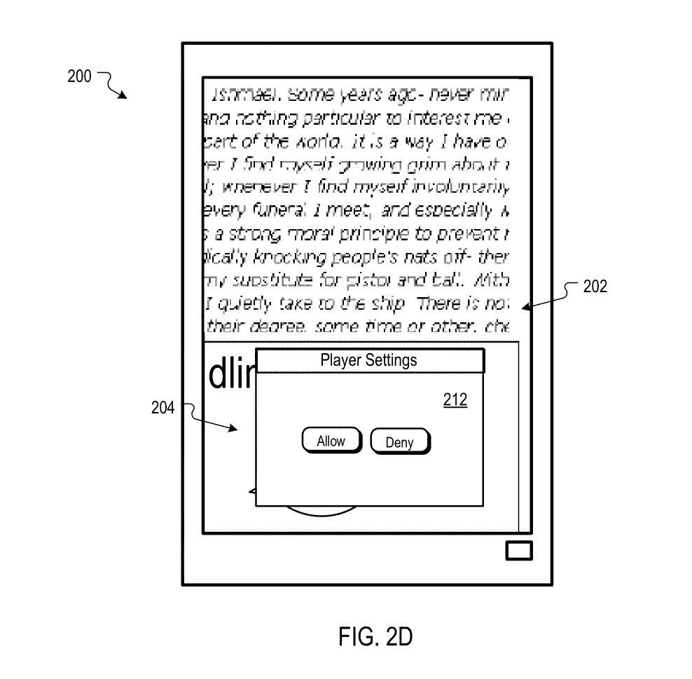

FIGS. 2A-2D are screenshots of example content displayed on one or more display panes in a media playing device. The screenshots in FIGS. 2A-2D can present multiple combinations of media content according to instructions from the display module 112, the content module 114, and/or the pan and zoom module 116. The presentations of content can be configured, modified, or otherwise manipulated to fit one or more content display areas within device 104, for example.

Referring now to FIG. 2A, a mobile phone device 200 is depicted with an HTML document on display. In this example, the HTML document is a portion of the first chapter of Moby Dick. The mobile phone device 200 includes a first content area 202 and a second content area 204. The content areas 202 and 204 are here included in a display pane in the display screen of device 104. Currently, a top left corner of the HTML document is shown. That is, the HTML document is shown justified left from the top of the first content area 202 in device 200. In the depicted example, the content area 204 includes a news headline 206, a story picture 208, and a link 210 to read more of the headline story. In some implementations, the content area 204 includes swf-based content. In some implementations, the content within both content areas 204 and 206 includes content of the same type, for example swf-based content.

Here, the content area 204 is currently shown in view, within the content area 206. In other situations, however, the content area 204 can be out of view, partially in view, or smaller or larger than shown in FIG. 2A. The content area 204 can have focus (e.g., by a user's cursor) or not have focus.

From time to time, the device 200 may receive a command to add additional content to the first content area 204. For example, the device 200 may display message panes for purpose of informing the user about something or to obtain user input. In some implementations, the message pane is generated based on the same file type from which the first content area 204 is created. For example, the first content area 204 may be swf-based and the device 200 may use swf-based message panes to communicate with the user (e.g., to show a dialog box that controls device settings.) In such situations, the device 200 can merge the new content (e.g., the dialog box) into, or otherwise integrate it with, the current content of the first content area 204. That is, the device 200 can use the first content area 204 as a suitable pane or window for showing additional (temporary) content that is based on the same file format. The device 200 can perform zooming and/or panning of the display pane to ensure that the content added to the first content area is fully visible (i.e., does not extend beyond the physical screen) and has an appropriate size (i.e., is not too small or too large to be useful). In the situation shown in FIG. 2A, it is sufficient to perform zooming of the display pane to accommodate the new content, and panning may therefore be omitted.

FIG. 2B shows the result of the performed panning action. The first and second content areas 202 and 204 are enlarged due to the zooming. The content area 204 currently has focus and displays a dialog box 212 to the user. The dialog box 212 represents additional content for display. In this example, the additional content (e.g., dialog box 212) includes a message requiring a user input to be made using at least one control (e.g., the “Allow” and “Deny” button controls).

The system 100 can perform a zooming and/or panning action to ensure that the message and any controls associated with the message are visible in the modified pane or content area. Here, the system 100 zoomed the HTML document in content area 202 and the swf content in content area 204 to ensure that the message and controls would be visible and easily selectable by the user.

In other words, the system 100 determines that the size of the additional content (e.g., the dialog box 212) requires the content area 204 to be zoomed to make the dialog box (e.g., message) 212 and the controls in the dialog box 212 visible and practically useful in the modified content area 204. Here, the zoom of the displayed content area 204 provides an ergonomically sound and convenient display to the user without requiring the user to manually pan or zoom content in device 200.

In other situations, a panning can be performed to accommodate additional content. Referring now to FIG. 2C, the device 200 is depicted with content in a zoomed form. The device 200 shows the content area 202 including the HTML document and the content area 204 before any additional content or dialog boxes are triggered. In this example, the content area 204 is currently shown only partially visible on the device 200 screen. For example, this situation can result after a zoom action is performed on the display pane shown in FIG. 2A. The content area 204 is an example of swf-based content that the system 100 may display.

At some point, the device 200 may receive a command to add additional content to the content area 204. For example, assume that the device 200 needs to display a dialog box or other message to the user. In the situation shown in FIG. 2C, it is sufficient to perform panning of the display pane to accommodate the new content, and zooming may therefore be omitted.

FIG. 2D shows the result of the performed panning action. The content area 204 has focus and displays a dialog box 212 to the user. The system 100 here determined that the size of the dialog box 212 requires the displayed content area 204 to be panned to make the dialog box 212 and the controls within the dialog box visible in the modified content area 204. As such, the system 100 can perform a panning action on the displayed content area 204 to ensure the dialog box 212 and corresponding controls are fully visible and selectable by a user.

The descriptions of zooming and panning are examples used for illustration. In some implementations, a combination of zooming and panning can be performed as necessary. Other actions affecting the screen (e.g., adjustment of a screen parameter), can be performed in connection with the zooming and/or panning

Upon viewing the modified displays shown in FIG. 2B or 2D, the user can select an option on the dialog box 212. Upon receiving the user's selection, the system 100 can perform another action of a panning action and a zooming action that at least in part reverses a result of the action. For example, the system 100 can revert the display including any or all modified content areas back to a default or previous state. In some implementations, the system 100 can determine the existence of a condition after receiving user input. This condition can be used to determine whether or not to perform other actions on the content areas.

In some implementations, the panning and/or zooming action may be selected based on a characteristic of a physical screen on device 104. The characteristic of the physical screen may include a physical-pixel density value. For example, the system 100 can determine an appropriate amount to zoom a particular document based on the size of a display area measured in physical pixels. The system 100 can also use the physical size of a particular pane as input for determining a zoom level. In some implementations, the panning and/or zooming action may be based on a physical-pixel density value of the display. The display can be the entire display area of device 104, content area 108, or content area 110, for example.

In some implementations, the panning and/or zooming action may be selected based on a determination of whether a particular content area displayed on the device currently has focus. For example, if the content area 110 has focus (e.g., a user's cursor actively selected area 110), then the system 100 may determine to ignore a command to zoom in content area 108. The command may be ignored because the user is currently focused and possibly actively using content area 110. Any modification to content area 108 may interrupt the user and as such, the system can make a decision to ignore commands based on whether a particular content area has focus.

In an illustrative example, the system 100 can pan and/or zoom a content area using a number of factors as input for panning and/or zooming. For example, the system 100 can use the screen dpi, the physical pixels of available content area, and one or more offsets pertaining to particular content areas or display screens to determine the degree with which to pan or zoom a content area or media content.

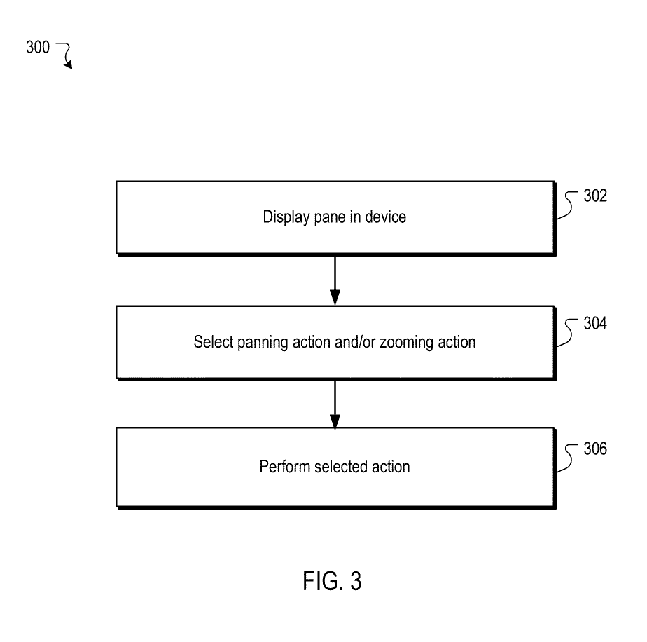

FIG. 3 is a sequential flow diagram of an example method 300 for displaying a modified display pane in a media playing device. The method 300 depicts the relationship between various system components in the method. Such components can be used for configuring the display of media content in device 104, for example. The method steps shown may be implemented using computer program code in combination with appropriate hardware, for example as a computer program product with processor instructions. Any method steps that are not explicitly mentioned in FIG. 3 may be implemented as described above with reference to FIGS. 1, 2A, 2B, 2C, and/or 2D.

In step 302, a pane is displayed in a device. For example, the pane may correspond to the display in device 200 having both content area 204 and content area 206 (FIG. 2A). The system 100 can determine how the panes should be displayed in device 200, for example.

In step 304, a panning action or a zooming action is selected in response to a command to add additional content. For example, the system 100 can select a panning or a zooming action to properly display content in one or more content areas. The panning and/or zooming action can be selected in response to a command from the system 100 to add additional content to the first content area 204, for example. The system 100 can select at least one action based on the size of the additional content.

In step 306, the selected action is performed. For example, the system 100 performs the panning action to display a modified pane having additional content in the first content area 204. In some implementations, the system 100 can select both the panning and the zooming action and perform the actions on one or more media content items or content areas within device 200.

Some portions of the detailed description are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus. The tangible program carrier can be a computer-readable medium. The computer-readable medium can be a machine-readable storage device, a machine-readable storage substrate, a memory device, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
displaying a pane in a device, the pane having first and second content areas;
in response to a command to add additional content to the first content area, selecting at least one action of a pan of the displayed pane and a zoom of the displayed pane, the action selected based on a size of the additional content; and
performing the selected action to display a modified pane having the additional content in the first content area.

2. The method of claim 1, wherein the additional content includes a message requiring a user input to be made using at least one control in the additional content, the action ensuring that the message and the control are visible in the modified pane.

3. The method of claim 2, further comprising:
determining that the size of the additional content requires the displayed pane to be panned to make the message and the control visible in the modified pane, wherein at least the pan of the displayed pane is performed.

4. The method of claim 2, further comprising:
determining that the size of the additional content requires the displayed pane to be zoomed to make the message and the control visible in the modified pane, wherein at least the zoom of the displayed pane is performed.

5. The method of claim 2, further comprising:
receiving the user input in the device after displaying the modified pane; and
performing, in response to receiving the user input, another action of a panning action and a zooming action that at least in part reverses a result of the action.

6. The method of claim 5, further comprising:
determining existence of a condition after receiving the user input, wherein performance of the other action depends on the condition.

7. The method of claim 1, wherein content in the first content area and the additional content are swf-based.

8. The method of claim 1, wherein the action is also based on a characteristic of a physical screen on the device.

9. The method of claim 8, wherein the characteristic of the physical screen includes a physical-pixel density value.

10. The method of claim 1, further comprising:
determining, before performing the action, whether the first content area displayed on the device currently has focus, wherein performance of the action depends on whether the first content area has focus.

11. A computer program product tangibly embodied in a tangible program carrier and comprising instructions that when executed by a processor perform a method comprising:
displaying a pane in a device, the pane having first and second content areas;
in response to a command to add additional content to the first content area, selecting at least one action of a pan of the displayed pane and a zoom of the displayed pane, the action selected based on a size of the additional content; and
performing the selected action to display a modified pane having the additional content in the first content area.

12. A device comprising:
a display;
a content module implemented in a computer-readable storage device, the content module presenting on the display a pane having first and second content areas; and
a pan and zoom module implemented in a computer-readable storage device, the pan and zoom module selecting and performing, in response to a command to add additional content to the first content area, at least one action of a pan of the displayed pane and a zoom of the displayed pane, the action selected based on a size of the additional content, wherein based on the action a modified pane is presented on the display, the modified pane having the additional content in the first content area.

13. The device of claim 12, wherein the additional content includes a message requiring a user input to be made using at least one control in the additional content, the action ensuring that the message and the control are visible in the modified pane.

14. The device of claim 13, wherein the pan and zoom module determines that the size of the additional content requires the displayed pane to be panned to make the message and the control visible in the modified pane, wherein the pan and zoom module performs at least the pan of the displayed pane.

15. The device of claim 12, wherein the pan and zoom module determines that the size of the additional content requires the displayed pane to be zoomed to make the message and the control visible in the modified pane, wherein the pan and zoom module performs at least the zoom of the displayed pane.

16. The device of claim 12, wherein the additional content and content in the first content area are swf-based.

17. The device of claim 12, wherein the action is also based on a physical-pixel density value of the display.
